(19) United States
(12) Patent Application Publication
(10) Pub. No.: US 2009/0028178 A1
(43) Pub. Date: Jan. 29, 2009

(54) Encoding and Decoding Messages on Noisy Timing Channels

(75) Inventors: Todd P. Coleman, Champaign, IL (US); Negar Kiyavash, Urbana, IL (US)

Correspondence Address: SADLER, BREEN, MORASCH & COLBY, P.S., 422 W. RIVERSIDE AVE., SUITE 424, SPOKANE, WA, 99201, US

(73) Assignee: The Board of Trustees of the University of Illinois, Urbana, IL (US)

(21) Appl. No.: 12/178,163

(22) Filed: Jul. 23, 2008

Related U.S. Application Data
(60) Provisional application No. 60/951,656, filed on Jul. 24, 2007.

(51) Int. Cl. H04L 29/04

(52) U.S. Cl. 370/464

(57) ABSTRACT

In accordance with one or more aspects of the encoding and decoding messages on noisy timing channels, a message is encoded, based at least in part on a cumulative distribution function, in inter-arrival timings of data packets. The data packets are output to a device with the message in the inter-arrival timings of the data packets. A the device, the inter-arrival timings of the data packets are identified. The message encoded in the inter-arrival timings is decoded based at least in part on a model representing noise between a source of the data packets and the device.

### RELATED APPLICATIONS

This application claims the benefit under 35 U.S.C. §119(e) of U.S. Provisional Application No. 60/951,656 filed Jul. 24, 2007, which is hereby incorporated by reference herein.

### BACKGROUND

Timing channels can be used to encode information in the timing of data sent by a transmitter. In real-world implementations, however, timing channels encounter difficulty in the face of noise. This noise can result from various sources, such as the presence of a device between the transmitter and receiver that buffers different data packets for different amounts of time. Accordingly, it can be problematic to implement timing channels reliably in real-world situations.

### SUMMARY

Encoding and decoding messages on noisy timing channels is discussed herein.

In accordance with one or more aspects of the encoding and decoding messages on noisy timing channels, inter-arrival timings of data packets at a device are identified. A message encoded in the inter-arrival timings is decoded based at least in part on a model representing noise between a source of the data packets and the device.

In accordance with one or more aspects of the encoding and decoding messages on noisy timing channels, a graphical structure of the conditional distribution of a departure process given an arrival process over a queuing timing channel is determined. Data communicated over the timing channel is identified based at least in part on the determining.

In accordance with one or more aspects of the encoding and decoding messages on noisy timing channels, a message is encoded, based at least in part on a cumulative distribution function, in inter-arrival timings of data packets. The data packets are output with the message in the inter-arrival timings of the data packets.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an example system employing the encoding and decoding messages on noisy timing channels in accordance with one or more embodiments.

FIG. 2 illustrates an example of noise being introduced into a timing channel in accordance with one or more embodiments.

FIG. 3 is a flowchart illustrating an example process for encoding and decoding messages on noisy timing channels.

FIG. 4 illustrates an example of the arrival process modeling in accordance with one or more embodiments.

FIG. 5 illustrates an example of arrival and departure times for packets using a first-come, first-serve queue in accordance with one or more embodiments.

FIG. 6 illustrates an example of the departure process modeling in accordance with one or more embodiments.

FIG. 7 illustrates an example normal graph capturing a state-space representation in accordance with one or more embodiments.

FIG. 8 is a block diagram illustrating an example computing device in which the encoding and decoding messages on noisy timing channels can be implemented in accordance with one or more embodiments.

### DETAILED DESCRIPTION

Encoding and decoding messages on noisy timing channels is discussed herein. A timing channel refers to a communication channel in which information is encoded into the timings of packets (also referred to as data packets) sent by a transmitter. The amount of time between the sending of two different packets can be used to encode one or more bits of data. A receiver observing packet timings uses a probabilistic decoder to recover the information encoded in the timings of the packets. The probabilistic decoder operates based at least in part on a model used to represent noise in the timing channel. This noise is modeled to be introduced by the queuing effects in operating systems, queuing effects in protocol stacks at the source/destination host, queuing effects in routers, etc. The probabilistic decoder recovers the information encoded in the timings of the packets despite the presence of such noise.

The timing channels can be used to transmit data independently of any content in the packets being transmitted. The data embedded in the timing channels can be related to the content in the packets being sent, or alternatively can be separate from any such content. The content in the packets can be encrypted content or plaintext, and can include any type of content (such as data and/or other control information) or may include no content.

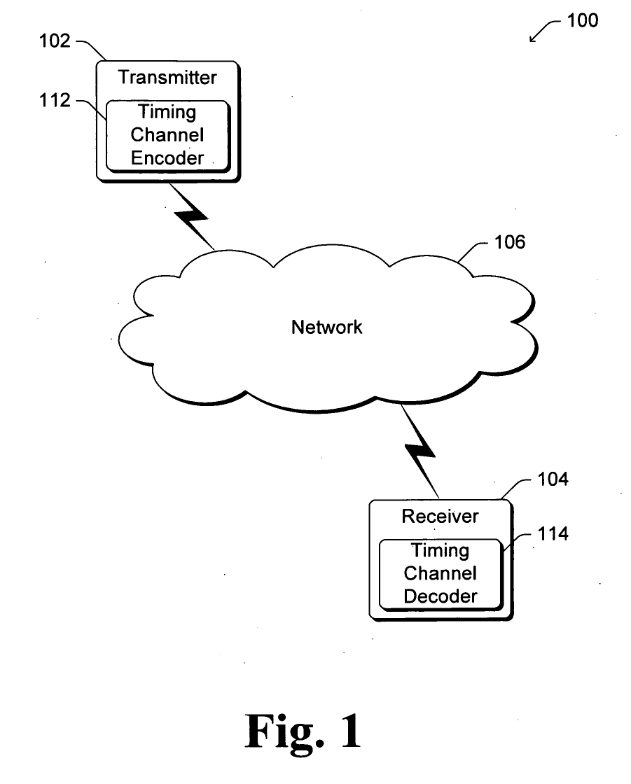

FIG. 1 illustrates an example system 100 employing the encoding and decoding messages on noisy timing channels in accordance with one or more embodiments. System 100 includes a transmitter 102 and a receiver 104 that can communicate with one another via a network 106. Network 106 can be any of a variety of different communications networks, including the Internet, a local area network (LAN), a wide area network (WAN), a personal area network (PAN), a telephone network, a cellular or other wireless phone network, and so forth. Network 106 allows signals to be transferred between transmitter 102 and receiver 104 via wired and/or wireless connections.

Transmitter 102 includes a timing channel encoder 112 that encodes information into inter-arrival timings of packets. Encoder 112 encodes information into the timing channel by use of an error-correcting code and a method to map uniform symbols to non-uniform inter-arrival packet timings, as discussed in more detail below. In one or more embodiments encoder 112 outputs the packets to network 106 directly, while in other embodiments encoder 112 outputs the packets to another component or module that outputs the packets to network 106 with the timings between packets generated by encoder 112. Transmitter 102 can also include a processor and/or other components or modules for performing additional functionality, such as generating or receiving messages to be encoded on the timing channel, generating or receiving other data to be included in the packets being sent, and so forth.

Receiver 104 includes a timing channel decoder 114 that receives packets and decodes information that was encoded into a timing channel. In one or more embodiments decoder 114 receives the packets from network 106 directly, while in other another component or module receives the packets and forwards the packets to decoder 114 along with an indication of the timings between the packets. Receiver 104 can also include a processor and/or other components or modules for performing additional functionality, such as outputting or otherwise processing a message decoded from the timing channel, processing other data included in the received packets, and so forth.

Although only one transmitter 102 and one receiver 104 are shown in FIG. 1, it is to be appreciated that multiple transmitters and multiple receivers can communicate with one another via network 106. Additionally, it is to be appreciated that receiver 104 can also operate as a transmitter (and include a timing channel encoder), and that transmitter 102 can also operate as a receiver (and include a timing channel decoder).

Each of transmitter 102 and receiver 104 can be a variety of different devices capable of transmitting and/or receiving packets. Additionally, transmitter 102 and receiver 104 can be the same type of device, or alternatively different types of devices. By way of example, transmitter 102 and receiver 104 can each be a desktop computer, a laptop computer, a portable or handheld computer, a personal digital assistant (PDA), a server computer, an automotive computer, a cellular or other wireless phone, a set-top box, a game console, a portable music player, a digital or video camera, and so forth.

Network 106 can include one or more devices that assist in communicating packets between transmitter 102 and receiver 104. Examples of such devices include gateways, routers, servers, cell sites or base stations, and so forth. The nature and quantity of such devices encountered in communicating a data packet from transmitter 102 to receiver 104 can vary based on a variety of different factors, such as the type of network, the physical locations of transmitter 102 and receiver 104, the types of devices that transmitter 102 and receiver 104 are, and so forth.

In a timing channel the timing between the packets is used to encode information. The timing between packets is also referred to as the inter-arrival timings of the packets. However, one or more devices in network 106 can impose queuing delays on packets, which will alter the timings between the packets at the output of the network. Accordingly, such devices can introduce “noise” into the timing channel due to these different delays and queuing effects. As discussed in more detail below, the encoding and decoding messages on noisy timing channels discussed herein makes use of an error-correcting code to counter the effects of this noise.

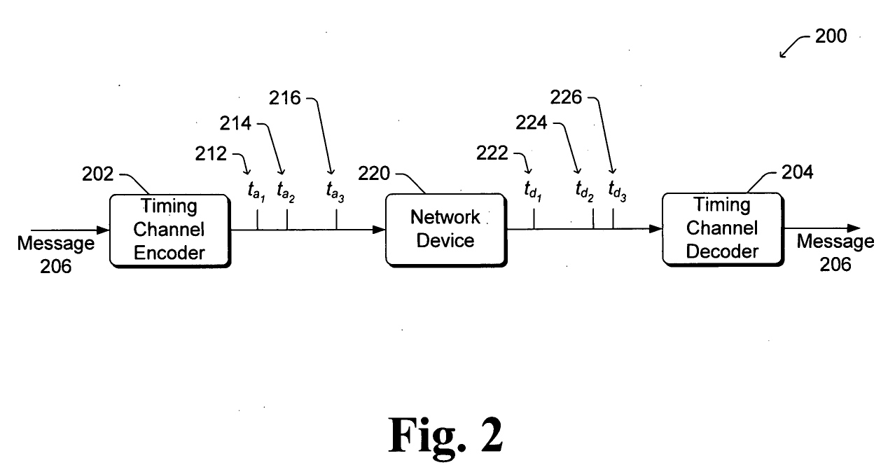

FIG. 2 illustrates an example of noise being introduced into a timing channel by queuing in accordance with one or more embodiments. System 200 includes a timing channel encoder 202, a timing channel decoder 204, and a network device 220. Encoder 202 can be, for example, an encoder 112 of FIG. 1, and decoder 204 can be, for example, a decoder 114 of FIG. 1.

In system 200, a message 206 is generated, received, or otherwise obtained by encoder 202, which uses an error-correcting code, and encodes message 206 into the timing channel. Generally, encoder 202 encodes message 206 based on a cumulative distribution function, as discussed in more detail below. Message 206 is encoded into the arrival times of packets sent by encoder 202. These arrival times refer to the times that the packets arrive at network device 220. The differences between these arrival times, also referred to as the inter-arrival timings, correspond to the differences between the times of arrival of the packets at network device 220. These inter-arrival timings also correspond to the differences between the times of sending of the packets by encoder 202. In system 200, arrival times for a first packet (a₁) 212, a second packet (a₂) 214, and a third packet (a₃) 216 are shown.

Message 206 is encoded in the amount of time between these packet times 212, 214, and 216. For example, a short amount of time between two packets can encode a value of “0”, while a long amount of time between two packets can encode a value of “1”. Following this example, a value of “0” may be encoded in the inter-arrival time between packet a₁ and packet a₂, while a value of “1” may be encoded in the inter-arrival time between packet a₂ and a₃. The specific amount of time that is a “short” amount of time and the specific amount of time that is a “long” amount of time can vary by implementation. Alternatively, three or more amounts of time can be used to encode three different values (e.g., a short amount of time encodes a value of “0”, a medium amount of time encodes a value of “1”, and a long amount of time encodes a value of “2”).

In one or more embodiments, the quantity of bits used to encode a message is known to both encoder 202 and decoder 204. This can be accomplished in a variety of different manners. For example, a predetermined message length can be known to both encoder 202 and decoder 204, a particular bit sequence can be used to identify the beginning and/or ending of a message in the timing channel, and so forth.

The packets sent by encoder 202 are received by a network device 220 which forwards the packets to decoder 204. Decoder 204 is the destination of the packets, and decoder 204 decodes message 206 based on the arrival times of the packets at decoder 204. Generally, decoder 204 determines the amount of time between two packets and, based at least in part on a model representing noise in the timing channel, performs a probabilistic decoding process to determine a value encoded in that amount of time. The manner in which message 206 is decoded from the timing channel is discussed in more detail below.

Various delays can be imposed on different packets by network device 220, resulting in a change in the timing of the packets as forwarded to decoder 204. In system 200, receipt times at the destination (decoder 204) are shown for the first packet (d₁) 222, the second packet (d₂) 224, and the third packet (d₃) 226. The differences between these times of receipt at the destination correspond to the differences between the times of departure of the packets from network device 220. Packet aₓ and packet dₓ are the same packet, although the timing of packet aₓ relative to the other packets can be different than the timing of packet dₓ relative to the other packets. For example, although both packets a₁ and d₁ are the same packet, and both packets a₂ and d₂ are the same packet, the amount of time between the packet times 212 and 214 is different than the amount of time between the packet times 222 and 224. By way of another example, although both packets a₂ and d₂ are the same packet, and both packets a₃ and d₃ are the same packet, the amount of time between the packet times 214 and 216 is different than the amount of time between the packet times 224 and 226. These differences are noise in the timing channel introduced by network device 220, and are accounted for by the encoding and decoding messages on noisy timing channels discussed herein.

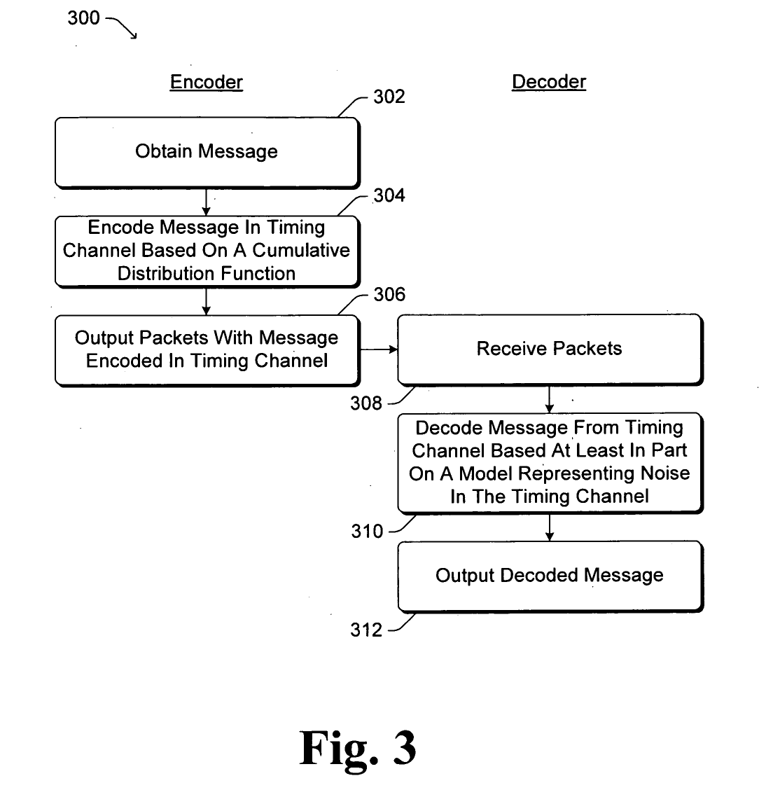

In the discussions herein, the noise introduced into the timing channel is described as being introduced by a network device 220. FIG. 3 is a flowchart illustrating an example process 300 for encoding and decoding messages on noisy timing channels. Process 300 can be implemented in software, firmware, hardware, or combinations thereof. Acts of process 300 illustrated on the left-hand side of FIG. 3 are carried out by an encoder, such as encoder 202 of FIG. 2 or encoder 112 of FIG. 1. Acts of process 300 illustrated on the right-hand side of FIG. 3 are carried out by a decoder, such as decoder 204 of FIG. 2 or decoder 114 of FIG. 1. Process 300 is an example process for encoding and decoding messages on noisy timing channels; additional discussions of encoding and decoding messages on noisy timing channels are included herein with reference to different figures.

In process 300, a message to be encoded in a timing channel is obtained (act 302). The message can be obtained in a variety of different manners, such as being sent or otherwise passed to the encoder, being retrieved by the encoder from an identified or otherwise known location, being generated by the encoder, and so forth.

The message is then encoded in the timing channel based on a cumulative distribution function (act 304). Any of a variety of different cumulative distribution functions can be used as a basis for encoding the message. The particular cumulative distribution function used in act 304 is also known to the decoder to be used as part of the decoding process, as discussed in more detail below. In one or more embodiments, the particular cumulative distribution function used in act 304 is selected so that the output of packets in act 306 is statistically the same as (e.g., is shaped to) other packets being sent by the encoder or being sent by other devices. Such shaping can assist in using the timing channel for covert communications, as discussed in more detail below.

Packets with the message encoded in the timing channel are output by the encoder (act 306) and received by the decoder (act 308). As discussed above, these packets can be, and oftentimes are, communicated through some other network device.

The decoder decodes the message from the timing channel (act 310). This decoding is based at least in part on a model representing noise in the timing channel, and is also based on the particular cumulative distribution function used in act 304. The model represents noise introduced into the timing channel by different network routings and/or network devices. A variety of different models can be used to model the noise introduced into the timing channel, and in one or more embodiments the model is an exponential server timing channel model. The output of the one or more network devices introducing the noise into the timing channel given the input to those one or more network devices is expressed as a product of independent exponential random variables that correspond to the service times of the packets. The service times of a packet refers to the amount of time taken by the one or more network devices to process the packet (e.g., the time between the one or more network devices receiving the packet and outputting the packet). The decoder expresses service times in terms of departure times and arrival times that having a recursive structure, as discussed in more detail below.

The decoder then outputs the decoded message (act 312). The message can be output as it is decoded, or alternatively parts of the decoded message can be held by the decoder until the full message is received and then the full message output. The outputting of the message can include one or more of sending the message to another component or module, sending the message to another device, processing or otherwise using the message by the decoder itself, and so forth.

Returning to FIG. 2, the rate of communication over a timing channel can vary based on numerous factors. In one or more embodiments, the noise introduced into the timing channel by network device 220 is modeled as a queue. In one or more embodiments, a theoretical maximum rate of communication using the timing channels exists as discussed in “Bits through queues” by V. Anantharam and S. Verdu, IEEE Transactions on Information Theory, 1996. In such embodiments, for a queue /M/1 with service rate μ, the theoretical maximum rate of communication (C) satisfies the following formulas:

$$\begin{matrix}C ( λ ) \geq λ {log}_{2} \frac{μ}{λ} , λ < μ ( bits \text{/} s ) & ( 1 a ) \\ C \geq {e}^{- 1} μ {log}_{2} e ( bits \text{/} s ) & ( 1 b )\end{matrix}$$

where the theoretical maximum C corresponding to formula (1b) is achieved in formula (1a) with an input Poisson process at a rate λ=e⁻¹μ. On average there will be n=λT packet transmissions arriving in T seconds, this can equivalently be stated using the following formulas:

$$\begin{matrix}\tilde{C} ( λ ) \geq {log}_{2} \frac{μ}{λ} , λ < μ ( bits \text{/} transmission ) & ( 2 a ) \\ \tilde{C} \geq {e}^{- 1} \frac{μ}{λ} {log}_{2} e ( bits \text{/} transmission ) & ( 2 b )\end{matrix}$$

Additionally, the theoretical maximum achievable rate for a Bernoulli λ process is given by:

$$C ( λ ) = h ( λ ) - \frac{λ}{μ} h ( μ ) bits \text{/} slot$$

where h( ) is the binary entropy function. The timing capacity is the supremum of λ-timing capacities over 0≦λ≦μ, and is given by:

$$C = ln [ 1 + exp ( - \frac{h ( μ )}{μ} ) ]$$

where the capacity-achieving λ* is given by the following formulas:

$$\begin{matrix}{λ}^{*} = \frac{ρ}{ρ + 1} & ( 3 ) \\ ρ {=}^{Δ} {e}^{- \frac{h ( μ )}{μ}} & ( 4 )\end{matrix}$$

The inter-arrival times of packets can be forced by the encoder to satisfy certain non-uniform probabilistic conditions, also referred to as shaping. These inter-arrival times of packets refer to the timing of packets being sent by encoder 202 (e.g., packet times 212, 214, and 216). In the discrete-time case, the inter-arrival times are expected to be independent and identically distributed (i.i.d.) and also to follow a geometric distribution. In the continuous case, the inter-arrival times are expected to follow an exponential distribution. A random variable Z with arbitrary cumulative distribution function F_{Z}(z) can be constructed by constructing a uniform random variable U on [0,1] and then constructing Z as:

Z=F_{Z}⁻¹(U) (5)

For example, an exponential random variable with parameter λ has cdf (cumulative distribution function) given by F_{Z}(z)=1−e^{-λz}, so an exponential from a uniform can be constructed as:

$$\begin{matrix}U = {F}_{Z} ( Z ) \\ = 1 - {e}^{- λ Z}\end{matrix} \\ ⇒ {e}^{- λ Z} = 1 - U \\ ⇒ Z = \frac{- ln ( 1 - U )}{λ} \qquad ( 6 )$$

By way of another example, in discrete time a geometric random variable with heads probability λε(0,1) has cdf given by F_{Z}(k)=1−(1−λ)^{k}, so a geometric from a uniform can be constructed as:

$$\begin{matrix}U = {F}_{Z} ( Z ) \\ = 1 - {( 1 - λ )}^{Z}\end{matrix} \\ ⇒ {( 1 - λ )}^{Z} = 1 - U \\ ⇒ Z = ⌈ \frac{ln ( 1 - U )}{ln ( 1 - λ )} ⌉ \qquad ( 7 )$$

Accordingly, n independent and identically distributed uniform [0,1] random variables can be generated, {Uᵢ}ᵢ₌₁ⁿ, then the inter-arrival times Zᵢ can be generated according to formula (6) or formula (7).

Coding algebraically with the inter-arrival times is performed to construct the n independent and identically distributed uniform [0,1] random variables. Accordingly, consider a field size Q=2^{t}, where t represents an arbitrary non-negative integer, corresponding to the logarithm of the number of distinct inter-arrival times that will take place for our encoding. To combat queuing “noise” on the timing channel, the underlying symbols representing the inter-arrival times will be forced to come from an error-correcting code. Such underlying symbols will be denoted by Xᵢ. For each inter-arrival time Zᵢ, there will be an associated Xᵢ. Each Xᵢ lies in a finite field F_{Q}. Consider a matrix H with m<n rows and n columns over F_{Q}. A linear coset code C is defined as C={x: Hx=s.}. “H” is the parity-check matrix and “s” is termed a syndrome and both of these code parameters are known ahead of time at the encoder and decoder. In one or more embodiments, H and s will be picked in pseudo-random fashions. “H” will be chosen to have sparse graphical structure, as is commonplace for low-density parity-check codes (LDPCs). Each xᵢε{0, . . . , Q−1} is interpreted as a member of R, and the following is defined:

$${U}_{i} = \frac{{X}_{i} + 0.5}{Q} \qquad ( 8 )$$

so that

$$\frac{0.5}{Q} \leq {U}_{i} \leq 1 - \frac{0.5}{Q} .$$

It should be noted that for the ensemble of random linear codes, the Xᵢ's will be uniformly distributed over {0, . . . , Q−1} and thus the Uᵢ's will be uniformly distributed over

$$\{ \frac{0.5}{Q} , \frac{1.5}{Q} , … , \frac{Q - 0.5}{Q} \} .$$

For large Q, this approximates a uniform distribution over [0,1]. Accordingly, Uᵢ can be obtained from Xᵢ using formula (8), and then Zᵢ can be obtained from Uᵢ using formula (5).

For the continuous time scenario, these formulas can be used as follows.

$$\begin{matrix}{Z}_{i} = h ( {X}_{i} ) \\ = \frac{- ln [ 1 - \frac{( {X}_{i} + 0.5 )}{Q} ]}{λ}\end{matrix} \qquad \begin{matrix}( 9 a ) \\ \\ ( 9 b )\end{matrix}$$

Since the rate for such a procedure is

$$R = \frac{{log}_{2} {Q}^{n - m}}{n}$$

bits per transmission, for an arrival Poisson process with rate λ and an exponential-μ server, the following holds:

$$R < C ( λ ) ⇔ ( 1 - \frac{m}{n} ) {log}_{2} Q < {log}_{2} \frac{μ}{λ}$$

So, for example, if m=¾n and Q=2⁴=16, then R=1 and if we let λ=1 and μ=4, then C(λ)=2.

For the discrete time scenario, these formulas can be used as follows.

$$\begin{matrix}{Z}_{i} = h ( {X}_{i} ) \\ = ⌈ \frac{ln [ 1 - \frac{( {X}_{i} + 0.5 )}{Q} ]}{ln ( 1 - λ )} ⌉\end{matrix} \qquad \begin{matrix}( 10 a ) \\ \\ ( 10 b )\end{matrix}$$

Since the rate for such a procedure is

$$R = \frac{{log}_{2} {Q}^{n - m}}{n}$$

bits per slot, for an arrival Bernoulli process with rate λ and a geometric-μ server, the following holds:

$$R < C ( λ ) ⇔ ( 1 - \frac{m}{n} ) {log}_{2} Q < h ( λ ) - \frac{λ}{μ} h ( μ )$$

So, for example, if m= 19/20n and Q=2⁴=16, then R=⅕ and if we let μ=0.75 and λ=λ*(μ)−0.2532, then C=ln(1+ρ)=0.2919.

Based on the discussions above, it can be seen that the arrival times of the packets at network device 220 satisfy the following:

$$\begin{matrix}{a}_{i} = {a}_{i - 1} + {z}_{i} & ( 11 a ) \\ = {a}_{i - 1} + h ( {x}_{i} ) & ( 11 b )\end{matrix}$$

The variable βᵢ is denoted to capture this as follows:

$${β}_{i} ( {a}_{i} , {a}_{i - 1} , {x}_{i} ) {=}^{Δ} {1}_{\{ {a}_{i} = {a}_{i - 1} + h ( {x}_{i} ) \}} \qquad ( 12 )$$

It should be noted that, although in this example the conditional probability distribution is a point mass, this architecture enables opportunities to place sources of randomness, such as dithers. Different cumulative distribution functions can be selected by the system designer, allowing the arrival process to have the statistical structure desired by the system designer, such as to evade covert communication detection.

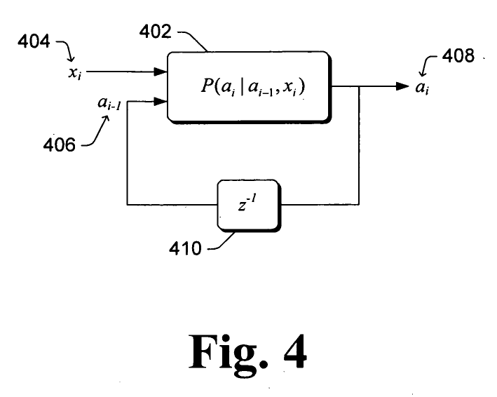

FIG. 4 illustrates an example of the arrival process modeling in accordance with one or more embodiments. In FIG. 4 the arrival process is modeled as a simple first-order stochastic dynamical system. The process 402 receives an exogenous input xᵢ 404 and an arrival time of the previous packet aᵢ₋₁ 406. The amount of time between the previous packet aᵢ₋₁ and the subsequent packet aᵢ 408 is represented by z⁻¹ 410. The probability of the subsequent packet aᵢ occurring at a particular time, given the timing of previous packet aᵢ₋₁ 406 and the exogenous input xᵢ 404 is represented by process 402 as P(aᵢ|aᵢ₋₁, xᵢ).

Returning to FIG. 2, network device 220 is modeled as a queue with a first-come, first-serve (FCFS) discipline. Packets arrive at network device 220 from encoder 202, and are output to decoder 204 in the same order as they arrived at network device 220. However, the timing between outputting packets to decoder 204 can be different than the timing of the arrival of the packets form encoder 202.

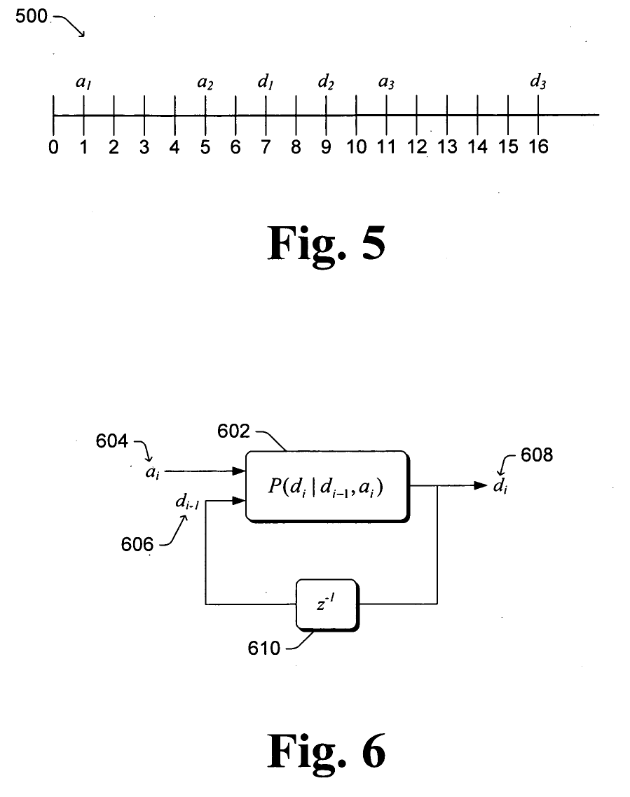

FIG. 5 illustrates an example of arrival and departure times for packets using a first-come, first-serve queue in accordance with one or more embodiments. In the example timeline 500 of FIG. 5, the arrival (aᵢ) times of packets at the network device are shown, as well as the departure (dᵢ) times of packets from the network device. For example, a first packet arrives at time 1 and departs at time 7, a second packet arrives at time 5 and departs at time 9, and a third packet arrives at time 11 and departs at time 16.

A service time (sᵢ) for each packet refers to the amount of time taken by the network device to process the packet. Accordingly, a service time for the first packet (s₁) is given by d₁−a₁=6. The first packet does not depart from the queue until after the second packet arrives. Thus, the service time for the second packet (s₂) is given by s₂=d₂−d₁, because the network device starts working on the second packet after the first packet is processed. The second packet departs before the arrival of the third packet, so the service time of the third packet (s₃) is s₃=d₃−a₃=5. Accordingly, in general it follows that:

sᵢ=dᵢ−max(aᵢ,dᵢ₋₁)=g(dᵢ,aᵢ,dᵢ₋₁)

For the continuous time scenario, service times sᵢ>0 can be exponentially distributed with μ, which can be represented as:

fₛ_{ᵢ}(s)=μe^{-μs}

Accordingly, the following holds:

$$P ( \underline{d} \vert \underline{a} ) = {\prod }_{i = 1}^{n} {f}_{{S}_{i}} ( g ( {d}_{i} , {a}_{i} , {d}_{i - 1} ) ) \\ = {\prod }_{i = 1}^{n} {1}_{\{ {d}_{i} > {a}_{i} \}} μ {e}^{μ g ( {d}_{i} , {a}_{i} , {d}_{i - 1} )}$$

For the discrete time scenario, service times sᵢ>0 can be geometrically distributed with μ, which can be represented as:

P(sᵢ=k)=μ(1−μ)^{k-1}, for k≧1

Accordingly, the following holds:

$$P ( \underline{d} \vert \underline{a} ) = {\prod }_{i = 1}^{n} P ( {s}_{i} = g ( {d}_{i} , {a}_{i} , {d}_{i - 1} ) ) \\ = {\prod }_{i = 1}^{n} {1}_{\{ {d}_{i} > {a}_{i} \}} {μ ( 1 - μ )}^{g ( {d}_{i} , {a}_{i} , {d}_{i - 1} ) - 1}$$

Thus, in both the continuous time and discrete time cases, it can be stated that:

$$P ( \underline{d} \vert \underline{a} ) = {\prod }_{i = 1}^{n} {f}_{i} ( {d}_{i} , {d}_{i - 1} , {a}_{i} )$$

where n denotes the number of packets, or code length, used to encode the message. For an appropriate choice of fᵢ(dᵢ, dᵢ₋₁, aᵢ) as:

$${f}_{i} ( {d}_{i} , {d}_{i - 1} , {a}_{i} ) = \{ \begin{matrix}{1}_{\{ {d}_{i} > {a}_{i} \}} {μ ( 1 - μ )}^{g ( {d}_{i} , {a}_{i} , {d}_{i - 1} ) - 1} , & for the discrete time case \\ {1}_{\{ {d}_{i} > {a}_{i} \}} μ {e}^{- μ g ( {d}_{i} , {a}_{i} , {d}_{i - 1} )} , & for the continuous time case\end{matrix} \qquad ( 13 )$$

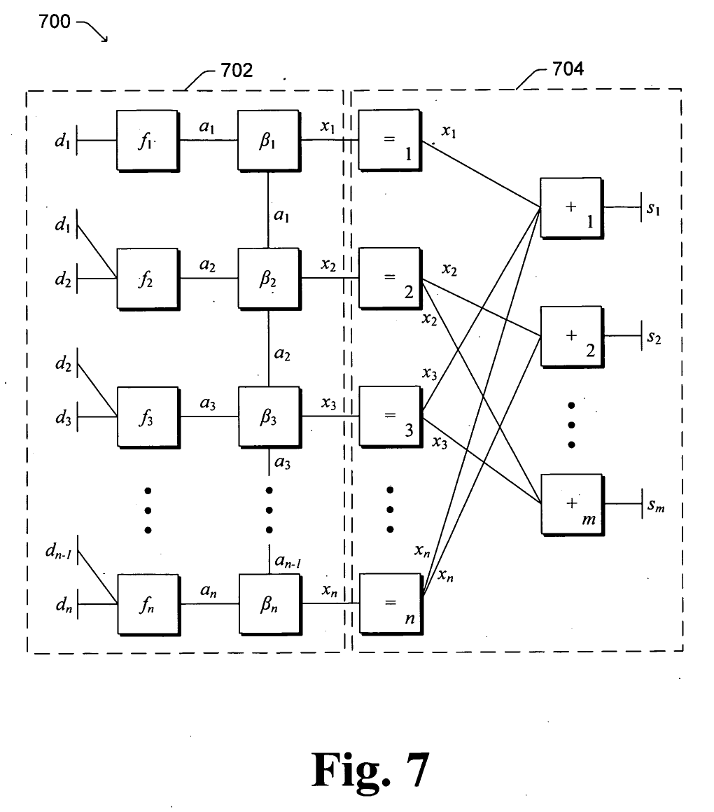

FIG. 6 illustrates an example of the departure process modeling in accordance with one or more embodiments. In FIG. 6 the departure process is modeled as a simple first-order stochastic dynamical system. The process 602 receives an exogenous input aᵢ 604 and a departure time of the previous packet dᵢ₋₁ 606. The amount of time between the previous packet dᵢ₋₁ and the subsequent packet dᵢ 608 is represented by z⁻¹ 610. The probability of the subsequent packet dᵢ occurring at a particular time, given the timing of previous packet dᵢ₋₁ 606 and the exogenous input aᵢ 604 is represented by process 602 as P(dᵢ|dᵢ₋₁, aᵢ).

In light of the above discussions, it can be seen that the joint likelihood of observable and unobservable state variables can be characterized as follows, where the function h is give by formula (9) or (10) above.

$$\begin{matrix}P ( \underline{d} , \underline{a} , \underline{x} ) = P ( \underline{d} \vert \underline{a} , \underline{x} ) P ( \underline{a} , \underline{x} ) \\ = P ( \underline{d} \vert \underline{a} ) [ {\prod }_{i = 1}^{n} {1}_{\{ {a}_{i} = {a}_{i - 1} + h ( {x}_{i} ) \}} ] \frac{1}{\vert C \vert} {1}_{\{ \underline{x} ∈ C \}} \\ = \frac{1}{\vert C \vert} [ {\prod }_{i - 1}^{n} {f}_{i} ( {d}_{i} , {d}_{i - 1} , {a}_{i} ) ] [ {\prod }_{i = 1}^{n} {β}_{i} ( {a}_{i} , {a}_{i - 1} , {x}_{i} ) ] {1}_{\{ H \underline{x} = \underline{s} \}} \\ = \frac{1}{\vert C \vert} {1}_{\{ H \underline{x} = \underline{s} \}} [ {\prod }_{i - 1}^{n} {f}_{i} ( {d}_{i} , {d}_{i - 1} , {a}_{i} ) {β}_{i} ( {a}_{i} , {a}_{i - 1} , {x}_{i} ) ]\end{matrix}$$

$$P ( \underline{a} , \underline{x} \vert \underline{d} ) = \frac{( \underline{d} , \underline{a} , \underline{x} )}{P ( \underline{d} )} \\ ⇒ P ( \underline{a} , \underline{x} \vert d ) ∝ {1}_{\{ H \underline{x} = \underline{s} \}} [ {\prod }_{i - 1}^{n} {f}_{i} ( {d}_{i} , {d}_{i - 1} , {a}_{i} ) {β}_{i} ( {a}_{i} , {a}_{i - 1} , {x}_{i} ) ]$$

This state-space representation can be captured using a Forney Factor Graph, also referred to as a “normal graph”. FIG. 7 illustrates an example normal graph capturing this state-space representation P(a, x|d) in accordance with one or more embodiments. In FIG. 7, a normal graph 700 having a portion 702 and a portion 704 is shown. It should be noted that by viewing the arrival process and departure process as first-order stochastic dynamical systems with appropriate exogenous inputs (as discussed above), portion 702 has no cycles. It should also be noted that portion 704 is a Forney Factor Graph of a Traditional Linear Coset Code.

Given this joint likelihood, a posteriori probabilities for decoding purposes can be determined. Using the sum-product algorithm on the normal graph 700, approximates of P(xᵢ|d) can be obtained to do decoding. It should be noted that there are no cycles in the factor graph representing

$${\prod }_{i - 1}^{n} {f}_{i} ( {d}_{i} , {d}_{i - 1} , {a}_{i} ) {β}_{i} ( {a}_{i} , {a}_{i - 1} , {x}_{i} ) .$$

So, given a good graphical representation for 1_{{Hx=s}} of a sparse graph linear coset code (e.g., an LDPC (low-density parity-check) coset code), then it can be postulated that a good approximate decoding also arises.

The following associations are performed:

associate node βᵢ with formula (12);

associate node rcᵢ with xᵢεF_{Q};

associate pcⱼ with 1_{{h*}_{ⱼ}ₓ₌ₛ_{ⱼ}^{}};

associate node fᵢ with formula (13).

Given these associations, a set of message-passing rules are used which are standard direct manifestations of the sum-product algorithm on Forney Factor Graphs. These message-passing rules are:

$$\begin{matrix}{μ}_{{β}_{i} \to {β}_{i - 1}} ( {a}_{i - 1} ) = {\sum }_{{x}_{i} = 0}^{Q - 1} {μ}_{{rc}_{i} \to {β}_{i}} ( {x}_{i} ) {μ}_{{f}_{i} \to {β}_{i}} ( {a}_{i - 1} + h ( {x}_{i} ) ) {μ}_{{β}_{I = 1} \to β i} ( {a}_{i - 1} + h ( {x}_{i} ) ) & ( 14 a ) \\ {μ}_{{β}_{i} \to {β}_{i + 1}} ( {a}_{i} ) = {\sum }_{{x}_{i} = 0}^{Q - 1} {μ}_{{rc}_{i} \to {β}_{i}} ( {x}_{i} ) {μ}_{{f}_{i} \to {β}_{i}} ( {a}_{i} ) {μ}_{{β}_{I = 1} \to {β}_{i}} ( {a}_{i} - h ( {x}_{i} ) ) & ( 14 b ) \\ {μ}_{{f}_{i} \to {β}_{i}} ( {a}_{i} ) = {f}_{i} ( {d}_{i} , {d}_{i - 1} , {a}_{i} ) & ( 14 c ) \\ {μ}_{{rc}_{i} \to {β}_{i}} ( {x}_{i} ) = {\prod }_{j ∈ N ( i )} {μ}_{{pc}_{j} \to {rc}_{i}} ( {x}_{i} ) & ( 14 d ) \\ {μ}_{{β}_{i} \to {rc}_{i}} ( {x}_{i} ) = {\sum }_{{a}_{i} - 1} {μ}_{{β}_{i - 1} \to {β}_{i}} ( {a}_{i - 1} ) {μ}_{{β}_{i + 1} \to {β}_{i}} ( {a}_{i - 1} + h ( {x}_{i} ) ) {μ}_{{f}_{I} \to β i} ( {a}_{i - 1} + h ( {x}_{i} ) ) & ( 14 e )\end{matrix}$$

Using these message-passing rules in formulas (14a)-(14e), the values of the bits (the values x) encoded in the inter-arrival times can be recovered from the inter-arrival times of the received data packets. The formulas (14a)-(14e) can be executed multiple times, resulting in the desired values x.

In one or more embodiments, the complexity of the execution of formulas (14a)-(14e) can be reduced by exploiting known properties of queuing systems. Although message-passing schemes in general take an order n (O(n)) amount of time and memory, for this scenario, formulas (14a)-(14c) have the variables aᵢ, which can take on values between 0 and dᵢ. Since dᵢ values are in general of size O(n), this means this message-passing scheme will have O(n²) complexity/memory requirements. This can be reduced to O(n) complexity by exploiting the fact that for queuing systems very general in nature, by Little's law, the expected system time E[Sᵢ]=dᵢ−aᵢ is a number that is independent of n. This leads to many approximation schemes to formulas (14a)-(14c) in which evaluating the message at a value of aᵢ where dᵢ−aᵢ is much greater than E[Sᵢ], can be replaced with something zero or near zero.

Thus, it can be seen that the techniques discussed herein allow messages to be communicated via a timing channel despite the presence of noise in the timing channel. Even though a network device may alter the inter-arrival of the packets, the message encoded therein can still be extracted.

The ability to communicate messages via a timing channel can be used in a variety of different situations. By way of example, covert messages can be communicated via the timing channel. The timings of other packets sent by the transmitter and/or other transmitters on the network can be analyzed and a cumulative distribution function selected so that the timings of the packets used by the timing channel are similar to those in the timings of the other packets. This results in it being difficult for another user to even be aware that covert messages are being communicated over a timing channel.

By way of another example, additional data related to the data in the packets can be communicated via the timing channel. This can result in increasing the rate of transfer of data between the transmitter and the receiver due to the data being transferred in both the data packets and the timing channel.

By way of yet another example, data can be communicated via the timing channel without altering the protocol of the data packets themselves. No changes to data packet headers, contents, or the manner in which data packets are processed need be made.

By way of still another example, the timing channel can be used to embed a digital watermark for content being communicated in the data packets. For example, in a situation where content is being streamed from a particular transmitter to a receiver, an encoder at the particular transmitter can embed a digital watermark in the timing channel. A decoder at the receiver can verify the digital watermark, allowing the receiver to verify that the data packets being streamed to the receiver were actually sent by that particular transmitter. If a malicious user or transmitter were to attempt to stream the data packets to the receiver, the decoder can detect that the data packets do not have the correct digital watermark and thus are not actually from that particular transmitter.

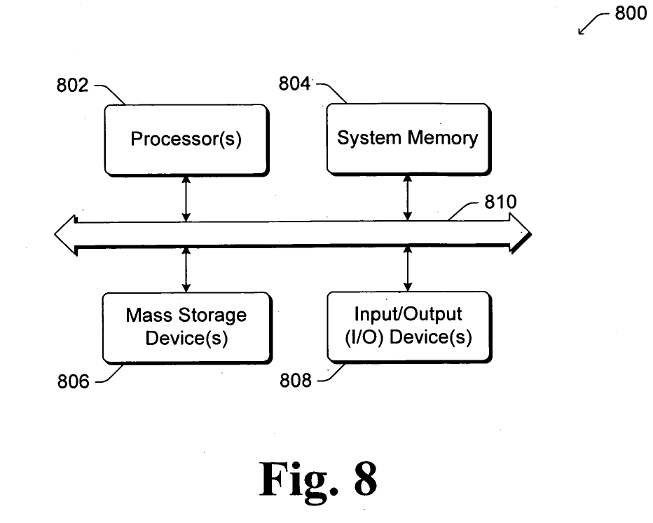

FIG. 8 is a block diagram illustrating an example computing device 800 in which the encoding and decoding messages on noisy timing channels can be implemented in accordance with one or more embodiments. Computing device 800 can be used to implement the various techniques and processes discussed herein. Computing device 800 can be any of a wide variety of computing devices, such as a desktop computer, a server computer, a handheld computer, a notebook computer, a personal digital assistant (PDA), an internet appliance, a game console, a set-top box, a cellular phone, a digital camera, audio and/or video players, audio and/or video recorders, and so forth.

Computing device 800 includes one or more processor(s) 802, system memory 804, mass storage device(s) 806, input/output (I/O) device(s) 808, and bus 810. Processor(s) 802 include one or more processors or controllers that execute instructions stored in system memory 804 and/or mass storage device(s) 806. Processor(s) 802 may also include computer readable media, such as cache memory.

System memory 804 includes various computer readable media, including volatile memory (such as random access memory (RAM)) and/or nonvolatile memory (such as read only memory (ROM)). System memory 804 may include rewritable ROM, such as Flash memory.

Mass storage device(s) 806 include various computer readable media, such as magnetic disks, optical disks, solid state memory (e.g., flash memory), and so forth. Various drives may also be included in mass storage device(s) 806 to enable reading from and/or writing to the various computer readable media. Mass storage device(s) 806 include removable media and/or nonremovable media.

I/O device(s) 808 include various devices that allow data and/or other information to be input to and/or output from computing device 800. Examples of I/O device(s) 808 include cursor control devices, keypads, microphones, monitors or other displays, speakers, printers, network interface cards, modems, lenses, CCDs or other image capture devices, and so forth.

Bus 810 allows processor(s) 802, system 804, mass storage device(s) 806, and I/O device(s) 808 to communicate with one another. Bus 810 can be one or more of multiple types of buses, such as a system bus, PCI bus, IEEE 1394 bus, USB bus, and so forth.

Although the description above uses language that is specific to structural features and/or methodological acts in processes, it is to be understood that the subject matter defined in the appended claims is not limited to the specific features or processes described. Rather, the specific features and processes are disclosed as example forms of implementing the claims. Various modifications, changes, and variations apparent to those skilled in the art may be made in the arrangement, operation, and details of the disclosed embodiments herein.

What is claimed is:

1. One or more computer readable media having stored thereon multiple instructions that, when executed by one or more processors of a device, cause the one or more processors to:
identify inter-arrival timings of data packets at the device; and
decode a message encoded in the inter-arrival timings based at least in part on a model representing noise between a source of the data packets and the device.

2. One or more computer readable media as recited in claim 1, the message having been encoded in the inter-arrival timings of the data packets based at least in part on a cumulative distribution function.

3. One or more computer readable media as recited in claim 1, the model comprising a queuing model based on service times, wherein a service time for a data packet refers to an amount of time taken by a network device to process the data packet.

4. One or more computer readable media as recited in claim 1, wherein a value n represents a quantity of the data packets used to encode the message, a value d represents a departure time of a data packet, and a value a represents an arrival time of the data packet, and wherein the model identifies a probability of a particular departure time of a data packet given a particular arrival time of the data packet as:
$$P ( \underline{d} \vert \underline{a} ) = {\prod }_{i = 1}^{n} {f}_{i} ( {d}_{i} , {d}_{i - 1} , {a}_{i} ) .$$

5. One or more computer readable media as recited in claim 1, wherein a value a represents an arrival time of a data packet, a value d represents a departure time of the data packet, and a value x represents a bit encoded into an inter-arrival time of data packets, wherein to decode the message is to decode the message based at least in part on a state-space representation P(a, x|d).

6. One or more computer readable media as recited in claim 1, wherein to decode the message is to decode the message using a set of formulas defined as:
$$\begin{matrix}{μ}_{{β}_{i} \to {β}_{i - 1}} ( {a}_{i - 1} ) = {\sum }_{{x}_{i} = 0}^{Q - 1} {μ}_{{rc}_{i} \to {β}_{i}} ( {x}_{i} ) {μ}_{{f}_{i} \to {β}_{i}} ( {a}_{i - 1} + h ( {x}_{i} ) ) {μ}_{{β}_{I = 1} \to β i} ( {a}_{i - 1} + h ( {x}_{i} ) ) , \\ {μ}_{{β}_{i} \to {β}_{i + 1}} ( {a}_{i} ) = {\sum }_{{x}_{i} = 0}^{Q - 1} {μ}_{{rc}_{i} \to {β}_{i}} ( {x}_{i} ) {μ}_{{f}_{i} \to {β}_{i}} ( {a}_{i} ) {μ}_{{β}_{I = 1} \to {β}_{i}} ( {a}_{i} - h ( {x}_{i} ) ) , \\ {μ}_{{f}_{i} \to {β}_{i}} ( {a}_{i} ) = {f}_{i} ( {d}_{i} , {d}_{i - 1} , {a}_{i} ) , \\ {μ}_{{rc}_{i} \to {β}_{i}} ( {x}_{i} ) = {\prod }_{j ∈ N ( i )} {μ}_{{pc}_{j} \to {rc}_{i}} ( {x}_{i} ) , \\ and \\ {μ}_{{β}_{i} \to {rc}_{i}} ( {x}_{i} ) = {\sum }_{{a}_{i} - 1} {μ}_{{β}_{i - 1} \to {β}_{i}} ( {a}_{i - 1} ) {μ}_{{β}_{i + 1} \to {β}_{i}} ( {a}_{i - 1} + h ( {x}_{i} ) ) {μ}_{{f}_{I} \to β i} ( {a}_{i - 1} + h ( {x}_{i} ) ) .\end{matrix}$$

7. One or more computer readable media as recited in claim 6, wherein to decode the message is further to decode the message based at least in part on an assumption that an expected system of data packets is independent of a number of packets used to encode the messages.

8. A method comprising:
determining a graphical structure of a conditional distribution of a departure process given an arrival process over a timing channel; and
identifying data communicated over the timing channel based at least in part on the determining.

9. A method as recited in claim 8, the identifying being based at least in part on a queuing model based on service times, wherein a service time for a data packet refers to an amount of time taken by a network device to process the data packet.

10. A method as recited in claim 8, wherein a value n represents a quantity of data packets in the timing channel used to encode the data, a value d represents a departure time of a data packet, and a value a represents an arrival time of the data packet, and wherein the graphical structure is based at least in part on a model identifying a probability of a particular departure time of a data packet given a particular arrival time of the data packet as:
$$P ( \underline{d} \vert \underline{a} ) = {\prod }_{i = 1}^{n} {f}_{i} ( {d}_{i} , {d}_{i - 1} , {a}_{i} ) .$$

11. A method as recited in claim 8, wherein a value a represents an arrival time of a data packet, a value d represents a departure time of the data packet, and a value x represents a bit encoded into an inter-arrival time of data packets, wherein the graphical structure is based at least in part on a state-space representation P(a, x|d).

12. A device comprising:
a decoder module to decode, based at least in part on a model representing noise between a source of data packets and the device, a message encoded in inter-arrival timings of the data packets; and
a processor to process the message.

13. A device as recited in claim 12, the model comprising a queuing model based on service times, wherein a service time for a data packet refers to an amount of time taken by a network device to process the data packet.

14. A device as recited in claim 12, wherein a value n represents a quantity of the data packets used to encode the message, a value d represents a departure time of a data packet, and a value a represents an arrival time of the data packet, and wherein the model identifies a probability of a particular departure time of a data packet given a particular arrival time of the data packet as:
$$P ( \underline{d} \vert \underline{a} ) = {\prod }_{i = 1}^{n} {f}_{i} ( {d}_{i} , {d}_{i - 1} , {a}_{i} ) .$$

15. A device as recited in claim 12, wherein a value a represents an arrival time of a data packet, a value d represents a departure time of the data packet, and a value x represents a bit encoded into an inter-arrival time of data packets, wherein to decode the message is to decode the message based at least in part on a state-space representation P(a, x|d).

16. A device comprising:
an input/output component to receive a message; and
an encoder to encode, based at least in part on a cumulative distribution function, the message in inter-arrival timings of data packets.

17. A device as recited in claim 16, wherein the cumulative distribution function is given by a formula F_{Z}(z)=1−e^{-λz}.

18. A device as recited in claim 16, wherein the cumulative distribution function is given by a formula F_{Z}(k)=1−(1−λ)^{k}.

19. A device as recited in claim 16, wherein the cumulative distribution function is selected so that the inter-arrival times of the data packets are shaped to timings of other packets output by the device.

20. One or more computer readable media having stored thereon multiple instructions that, when executed by one or more processors of a device, cause the one or more processors to:
encode, based at least in part on a cumulative distribution function, a message in inter-arrival timings of data packets; and
output the data packets with the message in the inter-arrival timings of the data packets.

21. One or more computer readable media as recited in claim 20, wherein the cumulative distribution function is given by a formula F_{Z}(z)=1−e^{-λz}.

22. One or more computer readable media as recited in claim 20, wherein the cumulative distribution function is given by a formula F_{Z}(k)=1−(1−λ)^{k}.

23. One or more computer readable media as recited in claim 20, wherein the cumulative distribution function is selected so that the inter-arrival times of the data packets are shaped to timings of other packets output by the device.

24. A method comprising:
encoding, based at least in part on a cumulative distribution function, a message in inter-arrival timings of data packets; and
outputting the data packets with the message in the inter-arrival timings of the data packets.

25. A method as recited in claim 24, wherein the cumulative distribution function is given by a formula F_{Z}(z)=1−e^{-λz}.

26. A method as recited in claim 24, wherein the cumulative distribution function is given by a formula F_{Z}(k)=1−(1−λ)^{k}.

27. A method as recited in claim 24, wherein the cumulative distribution function is selected so that the inter-arrival times of the data packets are shaped to timings of other packets output by the device.
